(19) United States
(12) Patent Application Publication
(10) Pub. No.: US 2012/0237773 A1
(43) Pub. Date: Sep. 20, 2012

(54) METHOD FOR PRODUCING A FILM COMPOSITE MATERIAL AND A CARD BODY

(75) Inventors: Josef Riedl, Attenkirchen (DE); Andreas Braun, Munchen (DE)

(73) Assignee: GIESECKE & DEVRIENT GMBH

(21) Appl. No.: 13/511,209

(22) PCT Filed: Nov. 24, 2010
(86) PCT No.: PCT/EP2010/007135

§ 371 Date: May 22, 2012

(30) Foreign Application Priority Data
Nov. 24, 2009 (DE) 10 2009 054 338.4

(51) Int. Cl. B29C 47/06; B32B 27/08; B32B 27/36

(52) U.S. Cl. 428/412; 264/171.13; 428/480; 156/244.11

(57) ABSTRACT

A method for producing a foil composite material, in particular for use as a layer in a card body, preferably in a card body of a portable data carrier, whereby using a coextrusion process, at least a first plastic melt of plastic including a thermoplastic elastomer and at least a second plastic melt of plastic without a thermoplastic elastomer, are joined in such a fashion that a foil composite material is formed. This foil composite material contains one or several outer first layers of plastic without a thermoplastic elastomer, one or several middle second layers of plastic including a thermoplastic elastomer and one or several outer third layers of plastic without a thermoplastic elastomer.

The invention relates to a method for producing a foil composite material, in particular for use as a layer in a card body, preferably in a card body of a portable data carrier, as well as a corresponding method for producing the card body.

Upon producing card bodies, in particular for portable data carriers, such as e.g. chip cards, several plastic foils disposed above each other are laminated with each other, to thereby create a stable and break-proof card body. To improve the mechanical properties of such card bodies it is advantageous within the framework of the laminating process to employ foils of a thermoplastic elastomer, in particular based on a urethane basis. These foils are extraordinarily elastic and can considerably improve the break strength of the card structure. In the publication print EP 0 430 282 A2 a card body in the shape of a multilayer identity card is described, in which card respectively one layer of a thermoplastic elastomer is provided between the card core and corresponding cover foils.

The processing of foils of thermoplastic elastomer within the framework of a laminating process when producing a card body proves to be very difficult. Due to their high elasticity the foils are very limp. Further, such foils have a low glass transition temperature in the room temperature range, causing them to have adhesive properties. This leads to blocking upon stacking the foils, so that the foils in a stack are difficult to single and transport. So as to achieve sufficient bonding stiffness upon laminating such foils with other materials, it is additionally necessary to reach the glass transition point of the respectively other material. Since this glass transition point regularly lies above the melting point of thermoplastic elastomers, this frequently results in the thermoplastic elastomer floating off The result is that the used laminating machines must be cleaned frequently. Possibly even the foils adjoining the thermoplastic elastomer can start flowing as well and thus deform the layout print present thereon. It is possible to laminate at low temperatures to thus prevent the floating off of the foils. However, in this case as a rule no sufficiently good laminate bond is achieved.

In the document EP 0 384 252 B1 a foil composite material of a plurality of layers is shown, whereby a middle layer is formed of thermoplastic elastomer. This layer is adjoined by layers of thermoplastic plastics. Upon producing the composite material, on a foil that forms the middle layer, the further layers are applied, for example by coextrusion.

From DE 100 57 231 A1 a construction of multilayer laminated card bodies using coextrusion composite foils is known. The coextruded composite foils can be implemented so that an elastic layer formed of a thermoplastic elastomer (TPE) is arranged between two layers of material that is dimensionally stable under heat. The document generally indicates that coextrusion in principle allows the bonding of materials with different softening temperatures and viscosities, whereby the ratio of the viscosities of two materials can be above three. The document does not offer any more exact specifications regarding material combinations.

It is the object of the invention to produce a foil composite material in which materials with considerably deviating material properties are combined, which can be readily processed within the framework of manufacturing a card body and which leads to an improvement of the mechanical properties of a card body produced therewith.

This object is achieved by the method according to claim 1 and/or claim 8 and/or by the correspondingly produced foil composite material and/or card body. Further developments of the invention are defined in the dependent claims.

In the method according to the invention for producing a foil composite material by a coextrusion process at least a first plastic melt of plastic comprising thermoplastic elastomer and at least a second plastic melt of plastic without thermoplastic elastomer is joined in such a fashion that a foil composite material is formed. This composite material contains one or several outer first layers of plastic without thermoplastic elastomer, one or several middle second layers of plastic comprising thermoplastic elastomer and one or several outer third layers again of plastic without thermoplastic elastomer. As plastic for the middle layer or the middle two layers here a thermoplastic elastomer on urethane basis is employed. This plastic here represents a thermoplastic elastomer that differs considerably from the second plastic of the first and third layers regarding softening temperature and viscosity.

According to the invention a foil composite material is created by a simple production process, which foil composite material can be handled well within the framework of a later processing to produce a card body. This is achieved in that one or several middle layers that comprise thermoplastic elastomer are coated with one or several outer layers of plastic which does not have any thermoplastic elastomer components and is thus stiffer than the middle layer or layers. By using suitable materials for the outer layers there can in particular be achieved for the composite material a good laminating ability also at higher temperatures as well as non-blocking properties. By using a coextrusion process in which, in contrast to the above-mentioned publication print EP 0 384 252 B1, all plastics are joined in a molten state before leaving the corresponding wide slot nozzle of the extruder, a simple and efficient production of the composite material is achieved.

In a particularly preferred embodiment of the method according to the invention as plastics for the at least one second plastic melt polymer materials and in particular thermoplastics are used, preferably polyester or a polyester blend. This means that in the formed foil composite material the first and/or third layers comprise the corresponding polymeric or thermoplastic material. In a particularly preferred variant as materials for the first and/or third layers polycarbonate or copolyester are used, in particular polyethylene terephthalate copolyester, or a blend of polycarbonate with one or several other polyesters. The just mentioned materials ensure a good stiffness and good laminating ability of the foil composite material.

As plastic for the middle second layer or layers in principle a thermoplastic elastomer on urethane basis is employed. Depending on the application case here for the middle layers a pure thermoplastic elastomer or possibly also a blend of thermoplastic elastomer and other plastic materials can be used. For example the one or several second layers can comprise polyethylene terephthalate copolyester with a content of a thermoplastic elastomer on polyurethane basis, in particular with a content of 15% to 35% or from 50% to 75%. Preferably here as a central second layer a polyethylene terephthalate copolyester with a content of 50% to 75% of thermoplastic elastomer is used, whereby both sides of the central layer are adjoined by respectively a second layer of polyethylene terephthalate copolyester with a content of 15% to 35% of thermoplastic elastomer. If applicable, there is also the possibility that a central second layer of a pure thermoplastic elastomer is present, to both sides of which there adjoins respectively a layer of extrusion adhesive which serves for bonding with the respective outer first or third layers.

In a further embodiment of the method according to the invention the one or several first and/or second and/or third layers can be transparent and/or colored. In a preferred variant the one or several second layers are UV-stabilized or inherently UV-stable, whereby the one or several layers are preferably aliphatic types of thermoplastic elastomer on urethane basis. These types are more UV-stable than aromatic types. In a further variant as material for the one or several second layers preferably thermoplastic elastomer on urethane basis with an elongation at break according to DIN 53504 of at least 300% is used. Card bodies with a foil composite material of the above-mentioned materials have particularly good properties in view of stability and break strength.

In a further variant of the method according to the invention a foil composite material is formed whose one or several second layers have a Shore A hardness of 90 or higher and a Shore D hardness of 50 or higher, or whose one or several second layers have a Shore A hardness of 95 or lower and a Shore D hardness of 50 and lower. When as material for the one or several first and third layers polyethylene terephthalate copolyester is used, as thermoplastic elastomer of the one or several second layers preferably a material with a Shore A hardness of 50 to 95 and a Shore D hardness of 35 to 50 is used. When for the one or several first and third layers polycarbonate is used the one or several second layers preferably comprise a material with a Shore A hardness of 90 to 98 and a Shore D hardness of 50 to 70.

In the production of the foil composite material it has turned out to be particularly advantageous to carry out the coextrusion process at a mass temperature of 200° C. or higher, in particular at 230° C. or higher.

In a further embodiment a foil composite material is formed by means of the production method, the one or several second layers of said foil composite material having a total thickness between 20 μm and 100 μm, in particular between 30 μm and 60 μm, whereby the total thickness of the foil composite material preferably lies between 50 μm and 350 μtm, in particular between 100 μm and 300 μm. These thicknesses ensure a sufficient stability of the foil composite material during its processing and further lead to good material properties of a card body containing this foil composite material.

Besides the above-described process the invention further comprises a foil composite material produced with this method.

The invention further relates to a method for producing a card body, in particular for a portable data carrier, in which a foil composite material is produced with the above-described method according to the invention or such a foil composite material is provided, and in which a plurality of layers of plastic comprising at least one layer of a foil composite material are laminated with each other. A good laminate bond is achieved here by laminating at a temperature of between 120° C. and 200° C., in particular between 125° C. and 190° C., preferably between 130° C. and 180° C., particularly preferably between 130° C. and 140° C. or between 175° C. and 185° C. The pressure during lamination preferably lies between 10 bar and 60 bar, for example at 50 bar. When a foil composite material with outer layers of polyethylene terephthalate copolyester is used, laminating takes place preferably at temperatures between 130° C. and 140° C. at a pressure of 50 bar. When a foil composite material with outer layers of polycarbonate is used, laminating takes place preferably at temperatures between 175° C. and 180° C. at a pressure of 50 bar.

Preferably the laminating is carried out in a heating station and a cooling station, whereby the pressure in the heating station lies in particular between 10 bar and 40 bar (100 N/cm² to 400 N/cm²), preferably between 12.5 bar and 35 bar (125 N/cm² to 350 N/cm²). In contrast the pressure in the cooling station preferably lies between 20 bar and 70 bar (200 N/cm² to 700 N/cm²), particularly preferably between 25 bar and 60 bar (250 N/cm² to 600 N/cm²). The laminating time in the heating station and/or cooling station preferably lies respectively between 13 min and 25 min.

In a particularly preferred embodiment of the production method of the card body upon laminating the layers at least one of the cover layers and in particular both cover layers consist of the foil composite material. This variant has the advantage that when using the foil composite material according to the invention the basic structure of the card body does not have to be changed, but merely the overlay foils have to be replaced by the composite material.

In a further preferred variant of the production method the one or several outer first and/or third layers of the foil composite material consist of the same material as that layer which, upon laminating the card body, bonds with one of the outer first and/or third layers. Hereby a very good fusion of the foil composite material with the remaining layer structure of the card body is achieved.

Besides the above-described production method the invention further comprises a card body, in particular for portable data carriers, comprising a plurality of layers laminated above each other, whereby the card body is produced with this production method.

Embodiments of the invention will be described in detail subsequently with reference to the enclosed figures.

The figures are described as follows:

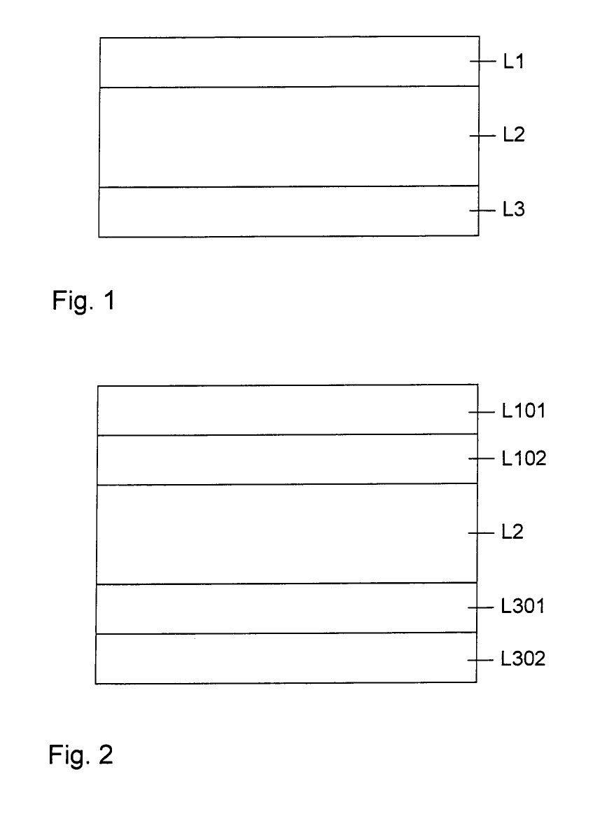

FIG. 1 the layer structure of a foil composite material obtained with a first variant of the method according to the invention;

FIG. 2 the layer structure of a foil composite material obtained with a second variant of the method according to the invention;

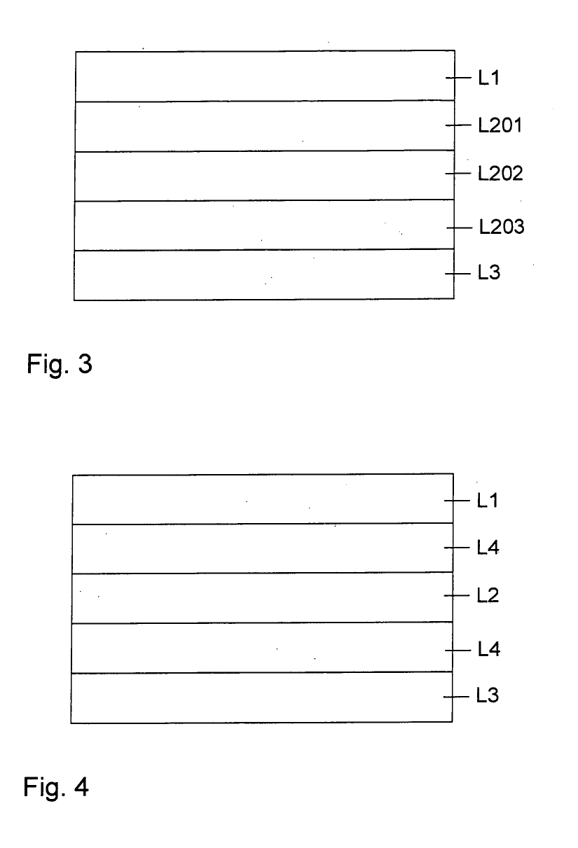

FIG. 3 the layer structure of a foil composite material obtained with a third variant of the method according to the invention;

FIG. 4 the layer structure of a foil composite material obtained with a fourth variant of the method according to the invention;

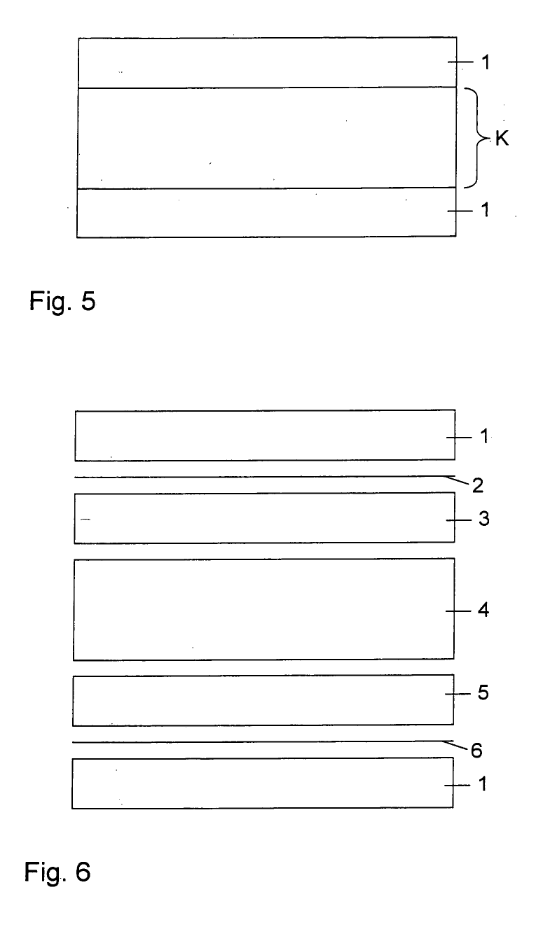

FIG. 5 the layer structure of a card body, comprising layers of a foil composite material produced with the method according to the invention; and

FIG. 6 a particularly preferred variant of a card body's layer structure according to the invention.

All embodiments of foil composite materials described in the following are characterized in that they are produced by a coextrusion process, in which the individual plastic melts are joined before exiting the wide slot nozzle used in the extrusion. Here in the coextrusion process one or several melts of material comprising thermoplastic elastomer (in the following also referred to using the standard abbreviation TPE) are bonded with one or several melts of stiffer plastic material without TPE in such a fashion that there results a composite material of one or several middle layers comprising TPE and one or several adjoining outer layers of stiffer material without TPE.

FIG. 1 shows a first embodiment of a foil composite material obtained with the coextrusion process according to the invention. The material comprises an upper outer layer L1, a single middle layer L2 and a lower outer layer L3. The middle layer L2 consists of the plastic of thermoplastic elastomer mentioned at the outset, whereby in particular a thermoplastic elastomer on urethane basis (in the following also referred to using the standard abbreviation TPU) is used. However, TPU here also represents other thermoplastic elastomers which, due to their physical properties that are comparable with TPU, also come into question for the middle layer L2, said thermoplastic elastomers differing considerably from the plastic of the outer layers L1, L3 regarding their softening temperature and viscosity. The thermoplastic elastomers employed for the middle layer L2 are hereinafter also referred to summarily as TPE/TPU.

In contrast the outer layers L1 and/or L3 are formed of a plastic without thermoplastic elastomer, whereby this plastic is configured so that, upon use in a later process for producing a card body for portable data carriers, it is able to be laminated also at higher temperatures and has a greater stiffness than the material of the layer L2. Moreover, the material should be non-blocking for the sake of better processing. Preferably as material for the layers L1 and/or L3 a polyester or copolyester is used. Particularly preferably polycarbonate (in the following also referred to as PC) is used, or polyethylene terephthalate copolyester (in the following also referred to using the standard abbreviation PETG) or a blend of polycarbonate and one or several other polyesters (in the following also referred to as PEC).

Preferably the layers L1 and L3 consist of the same material. However, if applicable, there is also the possibility that the materials of the layer L1 and of the layer L2 differ from each other through additives, for example the layer L1 can be transparent, whereas the layer L3 is no longer transparent due to the addition of additives, and is e.g. colored white. The total thickness of the layer structure of FIG. 1 preferably lies between 50 μm and 350 μm, particularly between 100 μm and 300 μm. The preferred thickness of the middle layer L2 lies between 20 μm and 100 μm, preferably between 30 μm and 60 μm.

FIG. 2 shows a second embodiment of a foil structure obtained with the method according to the invention. The foil structure again comprises one single middle layer L2 of thermoplastic elastomer, in particular of TPU. In contrast to the embodiment of FIG. 1 there are provided on both sides of the middle layer L2 respectively two outer layers L101 and L102 or L301 and L302. These layers in turn consist of a material without thermoplastic elastomer, in particular of PETG or PC or PEC. All layers L101, L102, L301 and L302 can consist of the same plastic or of different plastics, possibly with different additives. The total thickness of the foil structure of FIG. 2 preferably lies between 60 μm and 350 μm, in particular between 100 μm and 300 μm. The preferred thickness of the layer L2 lies at 20 μm to 100 μm, in particular between 30 μm and 60 μm.

In a preferred embodiment the type of the TPE/TPU plastic used for the layer L2 in the foil structure of FIG. 1 or FIG. 2 depends on the polymer type of the outside layers in the foil composite. It is thus more expedient when using temperature-stable materials, such as e.g. PC, for the outer layers to also use harder and more temperature-stable TPE/TPU types for the middle layer. In the case of outer layers of PETG it is preferable to use a TPE/TPU plastic with a Shore hardness of Shore A 50 to 95 or Shore D 35 to 50, whereby the mass temperature during coextrusion should preferably amount to approx. 200° C. When PC is used as material of the outer layers it is preferable that for the middle layer a TPE/TPU plastic with a Shore hardness of Shore A 90 or 98 or Shore D 50 to 70 is used, whereby upon coextruding the mass temperature should preferably amount to 235° C.

In the preceding embodiments pure TPU/TPE plastics or blends of these plastics were used for the middle layer L2. To improve the coextrusion process in a further embodiment, instead of a pure TPE/TPU layer a plastic blend with merely a predetermined TPU content is used as middle layer or middle layers. Such an embodiment of a layer structure is shown in FIG. 3. In this foil structure the outer layers L1 and L3 consist of PETG, possibly with anti-blocking additives or additives which make the layer capable of lasering. Instead of one middle layer L2 the layer structure of FIG. 3 now comprises three middle layers L201, L202 and L203. As already mentioned above, the materials used for this layer are no pure TPE/TPU plastics any longer, but plastics blends with a TPU content. In a particularly preferred variant the layer L201 is a PETG layer with approx. 15% to 35% TPU content. The layer L202 is also a PETG layer with approx. 50% to 75% TPU content. Also for the layer L203 a PETG plastic is used, which, analogously to the layer L201, again has a content of 15% to 35% TPU.

FIG. 4 shows a further variant of a layer structure that ensures a good bond between the TPU plastic used for the middle layer and the plastics of the outer layers via an extrusion adhesive. The embodiment of FIG. 4 comprises a single middle layer L2 of pure TPU plastic as well as two outer layers L1 and L3 which consist of PETG, possibly again with anti-blocking additives or additives ensuring the lasering ability of the material. To bond the TPU layer L2 with the outer layers L1 and L3, a suitable extrusion adhesive is used within the framework of the coextrusion process, said adhesive being introduced as intermediate layer L4 between the layers L1 and L2 and/or the layers L2 and L3.

The foil composite material which was produced with corresponding methods according to the preceding embodiments is employed within the framework of manufacturing a card body for a portable data carrier, in particular a chip card. By using thermoplastic elastomers here a high flexibility and tear strength of the card body is achieved, whereby further by integrating the TPE/TPU material in a composite material with outer materials that are highly able to be laminated and stiffer a very good processability of the material within the framework of a laminating process is ensured.

FIG. 5 shows schematically a preferred embodiment of a card body in which, within the framework of a laminating process, an above-described foil composite material was introduced. In FIG. 5 therein layers of foil composite material are designated with the reference numeral 1. Here in the card body two layers of foil composite material are applied as overlay layers on the actual card core K. The card core K can consist of one to seven foils and is composed of standard materials that are conventionally used in card bodies for data carriers. These materials comprise in particular PVC, ABS, polyester, polycarbonate, PEC and the like. The thickness of the respective layers 1 here is in the above-mentioned ranges between 50 μm and 350 μm, in particular between 100 μm and 300 μm or 100 μm and 200 μm. In comparison the thickness of the card core K lies between 100 μm and 700 μm, in particular between 200 μm and 600 μm.

The card body of FIG. 5 is produced by a suitable laminating process. Depending on the material used for the outer layers 1 the laminating takes place at temperatures between 120° C. and 200° C., preferably at 125° C. to 190° C. and particularly preferably at 130° C. to 180° C. The laminating process here is preferably carried out in a heating station and in a cooling station, whereby the pressures applied in these stations lie within ranges that were already defined above. The laminating time in the case of a 10-layer lamination in both the cooling station and the heating station preferably amounts to between 13 min and 25 min.

FIG. 6 again shows a special embodiment of a preferred layer structure of a card body according to an embodiment of the invention. Analogously to FIG. 5, again for the outer overlay layers 1 there are used the foil composite materials according to the invention, which comprise TPE/TPU plastic. Between the two overlay layers 1 there is disposed a layer structure of a color layer 2 that can be omitted if required, a thin layer 3 of thermoplastic foil, a thicker layer 4 of thermoplastic foil as well as again a thin layer 5 of thermoplastic foil. This layer 5 is adjoined by a further color layer 6, which can also be omitted analogously to the color layer 2. The structure is then concluded by the lower overlay foil 1.

The embodiments of the invention described above have a number of advantages. In the production of a card body a good processability of highly elastic TPU plastic is ensured by integration into a coextruded foil composite material. In particular by the outer layers of the foil composite material a sufficient laminating ability and stiffness are ensured.

By using the coextruded foil composite material the mechanical properties of the card body are improved. Therein it is mostly already sufficient to replace the two outermost overlay foils by the coextruded foil composite material, as shown in FIG. 5 and FIG. 6. It is hereby achieved that the conventional remaining structure of the card body can be maintained. Thus in a simple fashion, through minor variations of a conventional production process a card body with improved mechanical properties can be created.

1.-11. (canceled)

12. A method for producing a foil composite material, comprising the steps:
using a coextrusion process, joining at least a first plastic melt of plastic comprising thermoplastic elastomer and at least a second plastic melt of plastic without thermoplastic elastomer to form a foil composite material comprising one or several outer first layers of plastic without thermoplastic elastomer, one or several middle second layers of plastic comprising a thermoplastic elastomer on urethane basis and one or several outer third layers of plastic without thermoplastic elastomer;
at least one of said one or several outer first and third layers comprising polycarbonate, polyester, copolyester, a blend of polyesters or a blend of polycarbonate with one or several polyesters.

13. The method according to claim 12, wherein the one or several middle second layers comprise polyethylene terephthalate copolyester with a content of thermoplastic elastomer on urethane basis.

14. The method according to claim 12, including forming a foil of composite material, whose one or several middle second layers have a Shore A hardness of 90 or higher and a Shore D hardness of 50 or higher, or whose one or several middle second layers have a Shore A hardness of 95 or lower and a Shore D hardness of 50 or lower.

15. The method according to claim 2, wherein the coextrusion process is carried out at a mass temperature of 200° C. or higher.

16. A foil composite material made by the method recited in claim 12.

17. A method for producing a card body, comprising the steps:
providing or forming a foil composite material in accordance with the method recited in claim 12, and
laminating said foil composite material with a plurality of layers of plastic, said plurality of layers comprising at least one layer of the foil composite material.

18. The method according to claim 17, including carrying out the laminating step under pressure at a temperature of between 120° C. and 200° C., with the pressure during laminating being between 10 and 60 bar.

19. The method according to claim 17, wherein upon laminating the layers, at least one of the cover layers comprises the foil composite material.

20. A card body, comprising a plurality of layers laminated above each other, wherein the card body is made using the method recited in claim 17.
